(19) United States
(12) Patent Application Publication
(10) Pub. No.: US 2024/0178726 A1
(43) Pub. Date: May 30, 2024

(54) MAGNET-LESS AND BRUSH-LESS ROTATING TRANSFORMER EXCITED SYNCHRONOUS MACHINE AND METHOD OF ITS CONTROL

(71) Applicant: Volektra Inc., Utica, MI (US)

(72) Inventors: Manish Kumar Seth, Munich (DE); Luis Pont Lezica, Buenos Aires (AR)

(73) Assignee: Volektra Inc., Utica, MI (US)

(21) Appl. No.: 18/520,824

(22) Filed: Nov. 28, 2023

Related U.S. Application Data
(60) Provisional application No. 63/428,420, filed on Nov. 29, 2022.

(51) Int. Cl. H02K 11/049; H02K 7/08; H02K 19/12

(52) U.S. Cl. CPC H02K 11/049; H02K 7/083; H02K 19/12

(57) ABSTRACT

A synchronous machine (100) includes a housing, a shaft (106) to mount a three-phase rectifier (124), main motor (116) and a rotating transformer (RT) (108). The main rotor (110) is concentrically and co-axially mounted on shaft (106), and main stator (112) is concentrically and co-axially assembled over main rotor (110). Main rotor (110) includes Direct Current field windings and main stator (112) includes Alternating Current poly-phased distributed windings. Further, the RT (108) includes an RT rotor (120) and RT stator (122). RT rotor (120) and RT stator (122) may include AC poly-phase distributed windings and second predefined number of poles. Further, RT rotor (120) may be configured to be rotatably coupled on first end (106A) of shaft (106). The RT stator (122) may be configured to concentrically and co-axially assembled over RT rotor (120).

### CROSS REFERENCE TO RELATED APPLICATIONS

This application claims the benefit of U.S. Provisional Patent Application Ser. No. 63/428,420 filed Nov. 29, 2022 and titled “Magnet-Less, Brush-Less, Rotating Transformed Excited Synchronous Machine,” the entire disclosure of which is incorporated herein by reference.

### BACKGROUND

### Technical Field

This disclosure relates generally to electrical vehicles, and more particularly to electrical motors used in electrical vehicles and the method of its control.

### Related Art

Every Electric Vehicle (EV) uses an electric motor to power the drive train of the vehicle. Preferably, electric motor used in the EV must be light in weight and compact in size with high efficiency and high power density. Presently, most common type of electric motors used in the EV's are the asynchronous motor (ASM) and the permanent magnet synchronous motor (PMSM). On one hand, ASM has low efficiency and its torque-speed characteristic is far from ideal.

Further, the ASMs use slip rings to transfer power to the rotor field windings of the ASM from the stator field windings of the ASM that makes the ASM bulky and less efficient. The slip rings also cause copper losses and low power factor in the ASM. In addition to all these limitations, ASMs also require frequent maintenance due to the presence of slip rings which may wear and tear due to the continuous friction and circular motion.

On the other hand, PMSMs may overcome some of the limitations of ASMs such as, low efficiency, copper losses and use of slip rings but since the PMSMs use permanent magnets instead of rotor field windings in the rotor, their use is not sustainable due to environmental and geopolitical challenges. Permanent magnets are manufactured by a variety of processes including mining rare earth minerals from the earth's crust which may cause serious damage to the environment. Further, China dominates the rare earth minerals with about 85% market share in 2016. With this advantage, China has utilized rare earth minerals as a coercion tool against other nations including blocking exports to Japan and threatening to limit exports to the United States.

Therefore, the inventors have determined that there is a significant need for an improved, brush-less, magnet-less electric machine. There is a need for a cost-effective synchronous machine with contact-less energy transfer, overall reduced size, and longer life due to the reduced wear on its rotating parts.

### BRIEF SUMMARY OF THE DISCLOSURE

In an embodiment, a magnet-less and brush-less rotating transformer excited synchronous machine and method of its control is disclosed. The synchronous machine includes a housing which includes a first opening and a second opening. Further, the synchronous machine may include a shaft comprising a first end and a second end. Further, the synchronous machine includes a main motor which in turn may include a main rotor and a main stator. The main rotor is concentrically and co-axially mounted and positioned between the first end and the second end of the shaft. Further, the main rotor may include Direct Current (DC) field windings. The main stator of the main motor may be co-axially assembled over the main rotor and mechanically supported by the housing. Further, the main stator may include an electrically coupled Alternating Current (AC) poly-phase distributed windings and a first predefined number of poles. The synchronous machine also includes the rotating transformer (RT) that may be coaxially mounted and positioned between the first end and the second end of the shaft. The RT may further include an RT rotor, and an RT stator. Further, the RT rotor may be configured to be rotatably coupled on the second end of the shaft. The RT rotor may include the AC poly-phase distributed winding and a second predefined number of poles. Further, the RT stator may be co-axially assembled over the RT rotor and may include the AC poly-phase distributed winding. The RT stator may include the second predefined number of poles. Further, the synchronous machine may include a three-phase rectifier which may be configured to convert an AC current from the RT rotor to a DC current and transmits the DC current to the DC field windings of the main rotor in order to excite the synchronous machine. The synchronous machine may further include a ball bearing coupled to the first end of the shaft. Further, the synchronous machine may include a first endcap which may be configured to be attached to the first opening of the housing. The first end cap may further include a groove that may be configured to receive the ball bearing and enable rotational movement of the shaft. Further, the synchronous machine may include a second endcap which may be configured to be attached to the second opening of the housing. The second endcap may include an opening for the second end of the shaft to support an external radial load.

### BRIEF DESCRIPTION OF THE DRAWINGS

The accompanying drawings, which are incorporated in and constitute a part of this disclosure, illustrate exemplary embodiments and, together with the description, serve to explain the disclosed principles,

FIG. 1A illustrates an exploded perspective view of a salient pole or non-salient pole inner or outer rotor synchronous machine, in accordance with an embodiment of the present disclosure.

FIG. 1B illustrates a zoomed in exploded perspective view of the rotating transformer, in accordance with an embodiment of the present disclosure.

FIG. 2 illustrates a front sectional view of the salient pole or non-salient pole inner or outer rotor synchronous machine, in accordance with another embodiment of the present disclosure.

FIG. 3 illustrates a cross sectional view of the salient pole or non-salient pole inner or outer rotor synchronous machine, in accordance with another embodiment of the present disclosure.

FIG. 4 illustrates a radial view of the main rotor and main stator of the salient pole or non-salient pole inner or outer rotor synchronous machine, in accordance with another embodiment of the present disclosure.

FIG. 5 illustrates a radial view of the RT stator and the RT rotor of the salient pole or non-salient pole inner or outer rotor synchronous machine in accordance with another embodiment of the present disclosure.

FIG. 6 illustrates an electric circuit of the rotary transformer of the synchronous machine, in accordance with another embodiment of the present disclosure.

FIG. 7 illustrates a graph depicting RT output frequency in a transient state of the salient pole or non-salient pole inner or outer rotor synchronous machine, in accordance with another embodiment of the present disclosure.

FIGS. 8A and 8B illustrate an EMF generated due to the auxiliary magnetic flux in each of the stator phases of the salient pole or non-salient pole inner or outer rotor synchronous machine, in accordance with another embodiment of the present disclosure.

FIGS. 9A and 9B illustrate a demodulation of a signal of each of the phase for signal recovery and rotor position detection of the salient pole or non-salient pole inner or outer rotor synchronous machine, in accordance with another embodiment of the present disclosure.

FIG. 10 illustrates a rear perspective view of the salient pole or non-salient pole inner or outer rotor synchronous machine installed in an exemplary vehicle, in accordance with another embodiment of the present disclosure.

### DETAILED DESCRIPTION OF THE PREFERRED EMBODIMENTS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

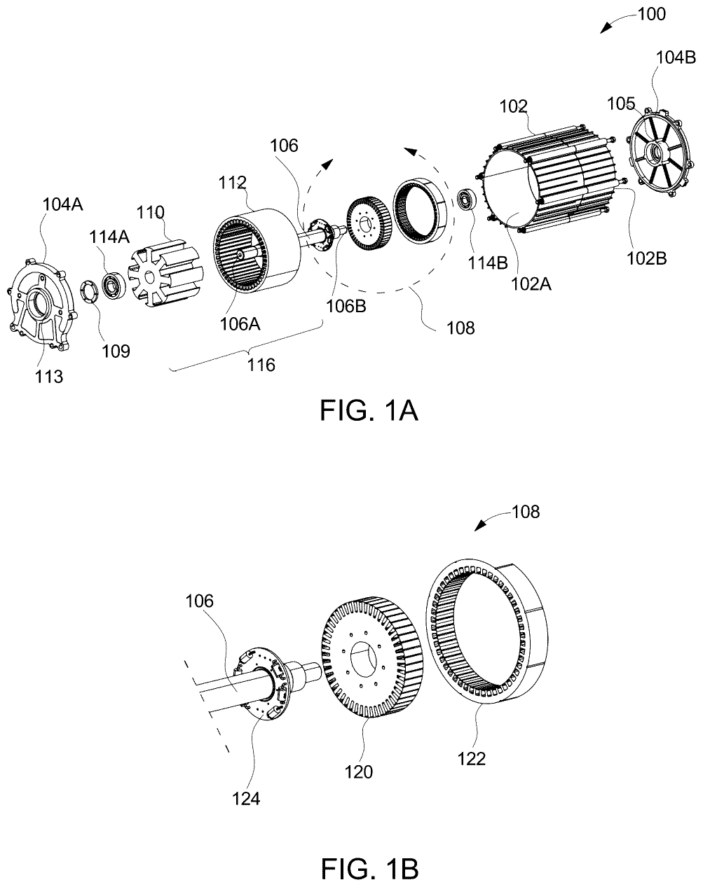

Referring to FIG. 1A, an exploded perspective view of a salient pole or a non-salient pole inner or outer rotor synchronous machine is illustrated, in accordance with an embedment of the present disclosure. In an embodiment, the machine 100 is excited using a rotating transformer. The machine 100 may include a housing 102 having a first opening 102A and a second opening 102B. The housing 102 may be configured to house various components of the machine 100. It may be noted that the machine 100 may be assembled by placing the components of the machine 100 in the housing 102. In an embodiment, the housing 102 may be casted and may feature cooling fins (not shown) in order to ensure proper ventilation and heat exchange.

Further, the machine 100 may include a first endcap 104A and a second endcap 104B. The first endcap 104A and the second endcap 104B may be configured to enclose the first opening 102A and the second opening 102B respectively of the housing 102. In an embodiment, the first endcap 104A and the second endcap 104B may be cast in a manner such that they are capable of withstanding radial loads.

In some embodiments, the machine 100 may include a shaft 106. The shaft 106 may be configured to cooperate with the rotating transformer 108. The shaft 106 may include a first end 106A and a second end 106B. In an embodiment, the first endcap 104A and the second endcap 104B may support the first end 106A and the second end 106B of the shaft 106 using permanently lubricated ball bearings 114A and 114B respectively. The first endcap 104A may include an aperture 113 and the second endcap 104B may include a groove 105 as a means to support the first end 106A and the second end 106B of the shaft 106 respectively in order for it to be suspended in the housing 102. The groove 105 may be dimensioned to fatigue and may be capable of withstanding alternating stress due to bending movement and static stress due to output torque. Further, in an embodiment, each of the first end 106A and the second end 106B of the shaft 106 are provided with V-seals 109, that may be dust seals capable of operating at high speeds and temperatures.

Referring now to FIG. 1B, a zoomed in exploded perspective view of the rotating transformer is illustrated, in accordance with an embodiment of the present disclosure. The rotating transformer (RT) 108 may include a RT rotor 120 and a RT stator 122 which may be concentrically and co-axially mounted on the shaft 106 positioned between the first end (106A) and the second end (106B) of the shaft (106). The RT 108 is explained in detail below.

Further, the machine 100 may include a main motor 116 having a main rotor 110 and a main stator 112 that may be concentrically and co-axially mounted on the shaft 106 and positioned between the first end 106A and the second end 106B of the shaft 106. The main rotor 110 of the machine 100 may include a number of poles which may be freely decided based on the usage of the machine 100. The main rotor 110 may include Direct Current (DC) field windings. It should be noted that the main rotor 110 may be a salient rotor or a non-salient rotor and the main rotor 110 may be an inner configuration rotor or an outer configuration rotor. Further, the main rotor 110 may be composed of cast iron, or a composite or a stamped steel center mated with the cast iron.

The main stator 112 of the machine 100 may be concentrically and co-axially assembled over the main rotor 110. The main stator 112 may be mechanically supported by the housing 102 on top. The main stator 112 may include a first predefined number of poles which may be equal to a number of poles of the main rotor 110. Further, the main stator 112 may include Alternating Current (AC) poly-phase distributed windings. It should be noted that the main stator 112 of the machine 100 may be, for example, a stranded stator or a hairpin stator and the main stator 112 may be, for example, either an inner configuration stator or an outer configuration stator. The main stator 112 may be configured to operate at any voltage level within the rated voltage of the machine 100.

Referring to FIG. 1A, the main motor 116 assembly may be mounted towards the first end 106A of the shaft 106. Further, on the other side towards the second end of 106B of the shaft 106 the RT 108 may be mounted. RT 108 may include a three-phase rectifier 124 which may be mounted between the main motor (116) and the assembly of the RT rotor 120 and the RT stator 122.

In an embodiment, the AC windings of the main stator 112 and the main rotor 110 may enable fixed output frequency to the three-phase rectifier 124 independent of the rotating speed. Further, the three-phase rectifier 124 may convert an AC current from the RT rotor 120 to a DC current. The DC current from the three-phase rectifier 124 in turn may be transmitted to the DC field windings of the main rotor 120 to excite the synchronous machine 100.

Referring now to FIG. 1B, the rotating transformer (RT) 108 may be configured to excite the field windings of the main motor 116 of the machine 100. The RT rotor 120 and the RT stator 122 of the RT 108 may be mounted on the shaft 106 and may rotate with the shaft 106. In some embodiments, the RT rotor 120 may be concentrically and co-axially mounted on the second end 106B of the shaft 106. The RT rotor 120 may include poly-phase AC distributed windings. The RT rotor 120 may include a second predefined number of poles, the number of which are preferably minimized to obtain low magnetizing susceptance and a low frequency to speed factor.

In some embodiments, the RT stator 122 may be concentrically and co-axially assembled over the RT rotor 120 of the RT 108. The RT stator 122 may include poly-phase AC distributed windings. Further, the RT stator 122 may include a second predefined number of poles. In simpler words, the number of poles of the RT rotor 120 is normally the same as the number of poles of the RT stator 122. Further, the RT stator 122 may be configured to operate at a fixed frequency, and below a knee magnetic point so as to ensure that no magnetizing susceptance depends on the voltage. In an embodiment, the number of poles in the RT rotor 120 may be, but not limited to, 2, 4 or 6.

In some embodiments, the machine 100 may include a three-phase rectifier 124. The three-phase rectifier 124 may be coaxially and concentrically mounted towards the second end 106B of the shaft 106. In an embodiment, the three-phase rectifier 124 may be a poly-phase bridge diode rectifier. Further, in an embodiment, the main rotor 110 is the inner configuration rotor and the three-phase rectifier 124 may be fixed to the shaft 106. In another embodiment, the main rotor 110 is an outer configuration rotor and the three-phase rectifier 124 is bearing-mounted on the shaft 106. Further, the three-phase rectifier 124 may include a plurality of diodes selected to withstand the high temperatures occurring inside the machine 100. Further, the plurality of diodes preferably have a short recovery time so as to operate at the RT 108 output frequency. Accordingly, the three-phase rectifier 124 is configured to operate at a frequency of the RT rotor 120. Further, the three-phase rectifier 124 may be configured to convert an AC current from the RT rotor 120 to a DC current and transmit the DC current to the DC field windings of the main rotor 110 to excite the machine 100. It should be noted that the three-phase rectifier 124 may be selected from a group of well-known three-phase rectifiers, preferably with diodes that withstand the high temperatures near the windings and hold firmly to the PCB while simultaneously resisting centrifugal stresses.

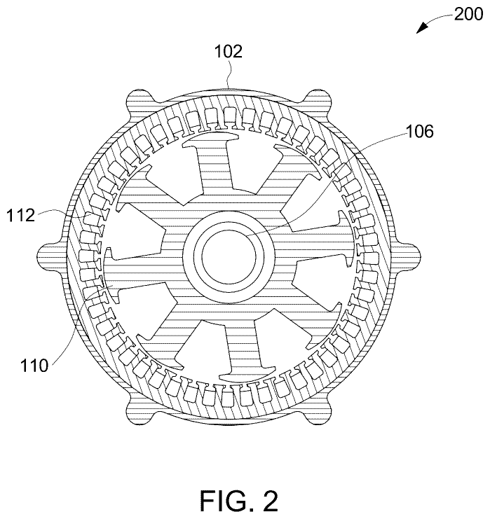

Referring now to FIG. 2, a front sectional view 200 of the salient pole or non- salient pole inner or outer rotor synchronous machine is illustrated, in accordance with an embodiment of the present disclosure. The machine 100 may include the shaft 106 at the center. Coaxially and concentrically mounted on the shaft 106 is the main rotor (120) of the main motor 116. Further, the main stator 120 of the main motor 116 is coaxially and concentrically mounted over the main rotor (120). Further, the main rotor 110 is coaxially and concentrically mounted on the shaft 106 between the main stator 112 and the shaft 106. The housing 102 may be chosen in a way to completely house the main stator 112 of the machine 100.

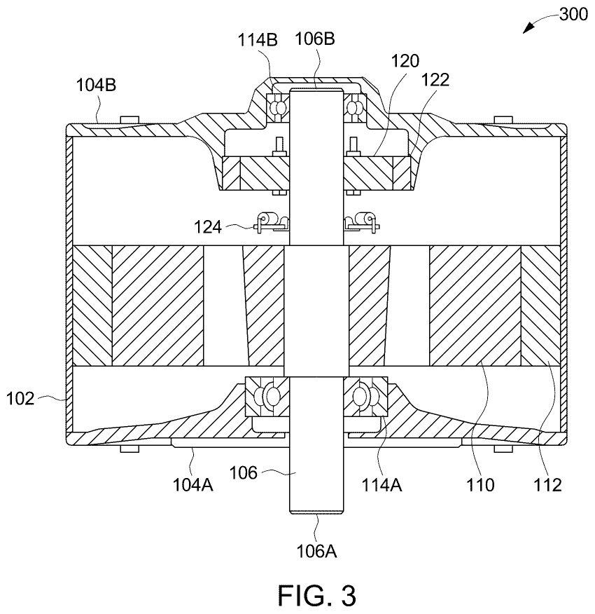

Referring now to FIG. 3, a cross-sectional view 300 of the salient pole or non-salient pole inner rotor synchronous machine is illustrated, in accordance with an embodiment of the present disclosure. FIG. 3 depicts a cross-sectional view 300 of an assembled salient pole or non-salient pole inner rotor synchronous machine 100 (also interchangeably referred as “machine”). The machine 100 may include a shaft 106 having a first end 106A and a second end 106B. Towards the first end 106A of the shaft 106 an assembly of the main motor 116 is mounted concentrically and co-axially mounted on the shaft 106. The main motor 116 may include a main rotor 110 mounted on the shaft 106 and a main stator 112 mounted on the main rotor 110. Further, the main motor assembly 116 may be supported by the first endcap 104A which in turn is attached to the first opening 102A of the housing 102. In an embodiment, the main motor assembly 116 may be supported by the first endcap 104A via a first bearing 114A. Further, the RT assembly comprising the RT stator 120 concentrically and co-axially mounted on the shaft 106 towards the second end 106B. Further, the RT rotor 122 is concentrically and co-axially mounted over the RT stator 120. The RT stator 120 and the RT rotor 122 assembly may be supported by a second endcap 104B via a second bearing 114B. The second endcap 104B is attached to the second opening 102B of housing 102. Further, the three-phase rectifier 124 is concentrically and co-axially mounted over shaft 106 between the main motor assembly 116 and the RT stator 120 and the RT rotor 122 assembly.

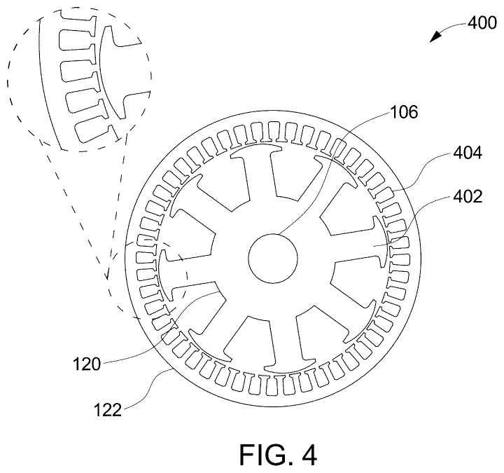

Referring now to FIG. 4, which illustrates a radial view 400 of the main motor, in accordance with an embodiment of the present disclosure. It may be noted that the zoomed in portion of FIG. 4 depicts one rotor pole and multiple stator slots. The number of poles of the main stator 122 may include the poly-phase AC distributed windings which may be powered by an external AC source. It should be noted that the main rotor 402 and main stator 122 may have an air gap between them to ensure the smooth rotation of the main rotor 402.

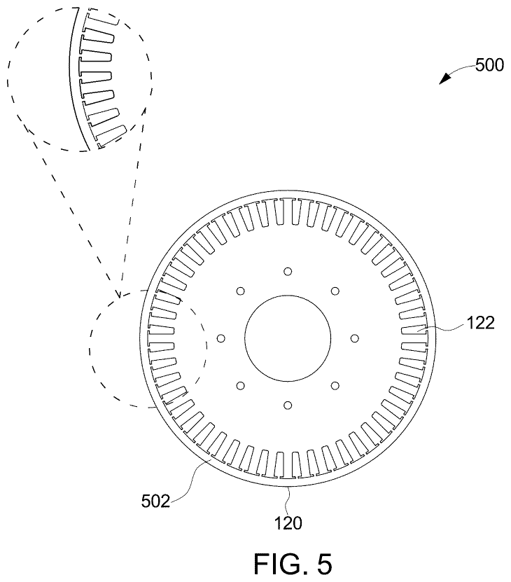

Referring now to FIG. 5, which illustrates a radial view 500 of the RT rotor 120 and the RT stator 120, in accordance with an embodiment of the present disclosure. It may be seen that the RT rotor 122 may be mounted on the shaft. The RT stator 120 may include a predefined number of poles that may also include the poly-phase AC distributed windings which may be powered by an external AC source.

In some embodiments, the AC poly-phase windings of RT rotor 120 and the AC poly-phase windings of RT stator 122 may be selected such that the current phase shift is zero to improve transient response. By way of an example, delta connected windings may be used but zero sequence harmonics may be avoided because the zero sequence non measurable currents may heat up the machine 100. Zero sequence harmonics may be mitigated with a proper winding design.

In another embodiment, a full pitched distributed windings may be used in the RT stator 122 and the RT rotor 120 which may produce a square wave output. On rectifying the square wave output, the size of the RT 108 may be reduced but the current control in the RT 108 may become unpredictable.

In another embodiment, a short pitch distributed winding may be used in the RT stator 122 and the RT rotor 120 which may produce a sinusoidal output. Upon rectifying the sinusoidal output, the size of the RT 108 may not be reduced, and efficiency of the RT 108 may reduce but the current control in the RT 108 may become easier.

Further, the RT 108 may be designed in a way such that the synchronous machine 100 may operate at any speed within the speed boundaries of the machine 100. The machine 100 may be configured to satisfy a plurality of constraints to operate efficiently. Further, any electric machine designing technique may be implemented to design the machine 100.

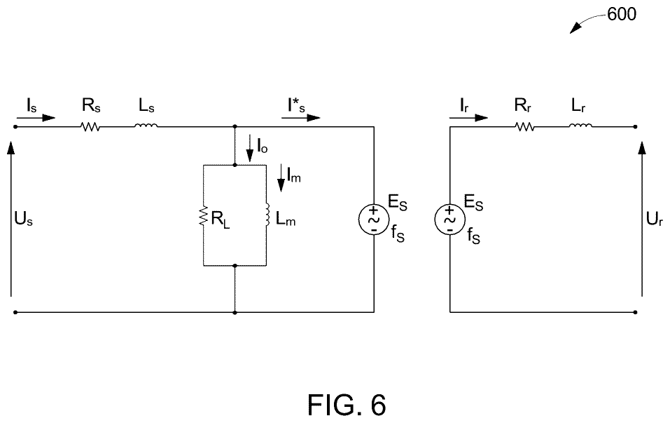

Referring now to FIG. 6, an electric circuit 600 of the rotary transformer 108 of the synchronous machine is illustrated, in accordance with an embodiment of the present disclosure.

A synchronous motor operates fundamentally on alignment torque at low speeds, but it can also operate on reluctance torque, generally at high speeds. To provide alignment torque, the machine needs a rotor MMF (Magneto Motive Force), generally denoted by Fᵣ. When applying a symmetrical and balanced three-phase current system to a three-phase symmetrical winding, a rotating MMF will give place in the machine airgap Fₛ. The rotor MMF Fᵣ will tend to align Fₛ, for providing torque. As Fₛ is constantly rotating, Fᵣ will be rotating too, and with it the motor shaft 106 will also rotate.

To produce Fᵣ, the machine needs a DC field winding in its rotor 120, or magnets. To provide DC current to the rotor 120 without the use of brushes, the inventive synchronous motor 100 is preferably equipped with the rotary three-phase transformer (RT) 108 combined with a rectifier 124. This RT 108 needs to operate at any speed, both negative and positive, and also at a stall. To do so, the DC current is preferably controlled precisely either using a mathematical algorithm or via a sensor mounted on the rotor. Finally, the RT output frequency is preferably as constant as possible independently of rotor speed to ensure a quality DC current output from the rectifier 124. The combination of these components, an optimized design and an adequate control system will yield an endurable, efficient, and power-dense machine. The inventive RT, in embodiments disclosed, allows for full speed range sensor-less control and rotor temperature sensor-less detection, two features that no electrical machine has to date. And because it has no magnets, it can handle high temperatures and demagnetizing currents, a valuable characteristic in applications for propelling small vehicles, 3-Wheelers and bikes.

In some embodiments, the poly-phase AC field windings of the main stator 112 may be excited by an AC power source. Upon excitation of the AC field windings of the main stator 112, the main stator 112 may produce a rotating magnetic field. Further, the DC field windings of the main rotor 110 may be excited by a DC power source. Upon excitation of the DC field windings of the main rotor 110, the main rotor 110 may produce a stationary magnetic field. It should be noted that the DC field windings of the main rotor 110 are excited by the RT 108 as explained in further detail in FIG. 6 below.

Further, the rotating magnetic-field of the main stator 112 may get locked with the stationary magnetic-field of the main rotor 110 and the main rotor 110 may rotate in synchronization with the frequency of the main stator 112. In simpler words, the speed of rotation of the main rotor 110 may depend on the frequency of the alternating current supplied to the main stator 112. Further, the speed of the main rotor 110 may be calculated in accordance with equation (1);

Ns=60f/P=120f/p (1)

where, f=frequency of the AC current
(Hz) p=total number of poles per phase
P=total pair number of poles per phase.

It should be noted that the electrical circuit 600 is the equivalent single-phase electrical circuit of the RT 108. The RT 108 is basically a three-phase stator 122 and a three-phase rotor 120 distributed winding machine. When applying a three-phase current to its stator winding, an electromagnetic field (EMF) is created within the rotor 120, and if the rotor 120 is connected to a load, electric current will flow.

In some embodiments, an alternating current may be applied to the three-phase AC windings of the main stator 112. Further, an electromotive force (EMF) may be induced in the RT rotor 120, or an electric current if the RT 108 is connected to a load. The electric circuit 600 may include:

Is: stator current
Io: no load current
Im: magnetizing current
Is*: stator load current
Ir: rotor current
Us: stator voltage Ur: rotor voltage
Rs, Rr, RL: stator, rotor, and core loss resistances
Ls, Lr, Lm: stator, rotor, and magnetizing inductances
Es, Er: stator and rotor EMFs
fs, fr: stator and rotor frequencies

It should be noted that the RT 108 does not produce torque as the RT 108 may transfer electric power from RT stator 122 to RT rotor 120 independently of the rotor speed. Further, the AC field windings of the RT rotor 120 may transfer the electric power to the DC field windings of the main rotor 110 through the three-phase rectifier 124. As the field windings of the main rotor 110 are DC windings, the three-phase rectifier 124 may convert the AC electric power from the RT rotor 110 into DC electric power. In an embodiment, the main rotor 110 may include AC field windings.

In some embodiments, a problem may arise with respect to the RT rotor 110 frequency as the machine speed may be variable. By way of an example, if the three-phase rectifier 124 is designed to operate at about 10 kHz, but at some speed the frequency goes below that, rectifying will lose quality and current ripple may take place in the field windings which may produce torque oscillations on the machine 100. The current disclosure provides a solution to solve this problem.

It should be noted that depending on the machine spinning direction of the machine 100, frequency (ƒᵣ) of the RT rotor 120 may increase or decrease as per equation (2) below.

ƒᵣ=ƒₛ±pn (2)

where, ƒs: RT stator 122 frequency; p: RT pole pairs; n: shaft speed

Accordingly, to keep the frequency (ƒᵣ) of the RT rotor 120 constant, one solution is to keep the number of poles as low as possible. In addition to keeping the number of poles to a minimum, the RT's core preferably remains unsaturated. This allows for easy control keeping the magnetizing inductance to be independent of voltage.

Accordingly, it may be noted that, the lesser number of poles the machine 100 has, the smaller the rotor frequency variations there is and the better the system may perform.

In some embodiments, one of the design constraints may be that the machine 100 output frequency must remain within the rectifier's adequate frequency limits regardless of the rotor speed. To meet this constraint, the designer may include as low as possible number of poles in the RT 108 to ensure low output frequency variation with respect to the rotor speed. Further, at stall, the RT rotor 120 frequency may be same as the frequency of the RT stator 122 but at positive speed the RT rotor frequency may change according to below equation:

ƒᵣ=ƒₛ+pn

But for negative speed, the RT rotor output frequency may change according to:

ƒᵣ=ƒₛ−pn

Thus, the three-phase rectifier 124 may be designed to operate correctly within the range of fᵣ. If the number of poles are very high, the output frequency may be very low at significant negative speeds which may produce current oscillations in the poly-phase AC field windings and consequently, torque ripples in the machine 100.

In some embodiments, one of the design constraints may be that the machine 100 must be efficient across the whole motor operating speed region. To insure the high efficiency of the synchronous machine 100, the frequency of the RT stator 122 may be increased, thus reducing the magnetizing current. Further, the numbers of poles may be kept minimum such that the magnetizing inductance increase, thus reducing the magnetizing current.

Therefore, there is a requirement that the RT 108 may be designed to operate at any speed within the speed boundaries of the main motor 116. It may be noted that for designing the machine 100 using any design techniques, it may be considered that the machine's magnetic circuit must operate in the linear region in order to ensure adequate current control. Further, the machine output frequency must remain within the rectifier's adequate frequency limits regardless of the rotor speed. Also, the machine 100 must be efficient across the whole motor 116 operating speed region.

In an embodiment, for the machine's magnetic circuit to operate in the linear region and in order to ensure adequate current control. The input RT stator frequency may be selected such that the magnetizing current at a given voltage is sufficiently low as not to saturate the core. This may be realized based on equation (4):

$$\dot{ϕ} ≅ - j \frac{{U}_{s}}{2 π {f}_{s}}$$

where,
ϕ: pole flux phasor
Uₛ: stator voltage phasor
ƒₛ: stator frequency

As shown in the equation (4) above, for a given voltage, flux may only be reduced by increasing frequency. Given the RT may be generally small in size, a large flux may tend to saturate the core, then RT stator frequency may have to be sufficiently high. Further, using low voltage may result in poor efficiency.

In another embodiment, to keep output frequency of the machine within the rectifier's adequate frequency limits regardless of the rotor speed. the number of poles of the RT rotor may be reduced to ensure low output frequency variation with respect to RT rotor speed. At stall state, the RT rotor frequency may be the same as the RT stator's and at positive speeds.

If RT rotor speed is negative the rectifier is preferably designed as to operate correctly within the range of fᵣ. Note that if the number of poles is very high, output frequency could be very low at significant negative speeds, producing current oscillations in the field winding, and consequently, torque ripple.

Further, the RT 108 may include windings which may be, but not limited to, a distributed winding type. It is to be noted that the RT stator 122 and RT rotor 120 have the same winding or different type of windings, but the vector group should be such that current phase shift is zero so as to improve transient response. In an embodiment, delta connected windings can be used, but if so, zero sequence harmonics are absolutely not allowed, otherwise, zero sequence non measurable currents will heat up the machine. In an embodiment, zero sequence harmonics can be mitigated with a proper winding design.

Accordingly, a full pitch distributed winding may favor a square wave output and rectifying, this may reduce the size of the RT 108, but current control may be more unpredictable. On the other hand, short pitching may give a sinusoidal output, efficiency and size may not be favored, but current control may be easier. Accordingly, the RT 108 may be designed to achieve a balance of required aspects.

In an embodiment, a three-phase full bridge inverter is used to control the RT 108. Commutation devices are selected depending on the current, voltage and frequency of the RT. Known PWM techniques may be employed to ensure full usage of the DC bus.

In an embodiment, the RT stator frequency shall remain fixed, but stator voltage may be changed depending on the desired field current, which will be discussed in detail below.

Referring now to FIG. 1 to FIG. 6, in an embodiment, the machine 100 may operate fundamentally on alignment torque at low speeds but the machine 100 may operate on reluctance torque at high speeds. To generate alignment torque, the machine 100 may need a rotor Magneto Motive Force (MMF) denoted by Fᵣ. When applying a symmetrical and balanced three phase current system to a three-phase symmetrical winding, a rotating MMF may generate in the machine 100 airgap, this may be denoted by Fₛ. The rotor MMF Fr may tend to align Fₛ providing the torque. As Fₛ is constantly rotating, Fᵣ will be too, and with it the machine 100 shaft 106.

Further, in order to produce Fᵣ, the machine 100 may need a DC field winding in the rotor. To provide the DC current to the main rotor 110 without the use of brushes, the RT 108 may be used in combination with the three-phase bridge rectifier 124. It should be noted that the RT 108 must operate at positive speed, negative speed, and at stall condition and the RT output frequency must remain as constant as possible independently on rotor speed as to ensure a quality DC current output from the rectifier 124. Further, the RT 108 may allow full speed range sensorless control and rotor temperature sensorless detection. Accordingly, RT 108 may be controlled via a three-phase full bridge inverter using one or more modulation techniques such as, but not limited to, a pulse width modulation technique, etc.

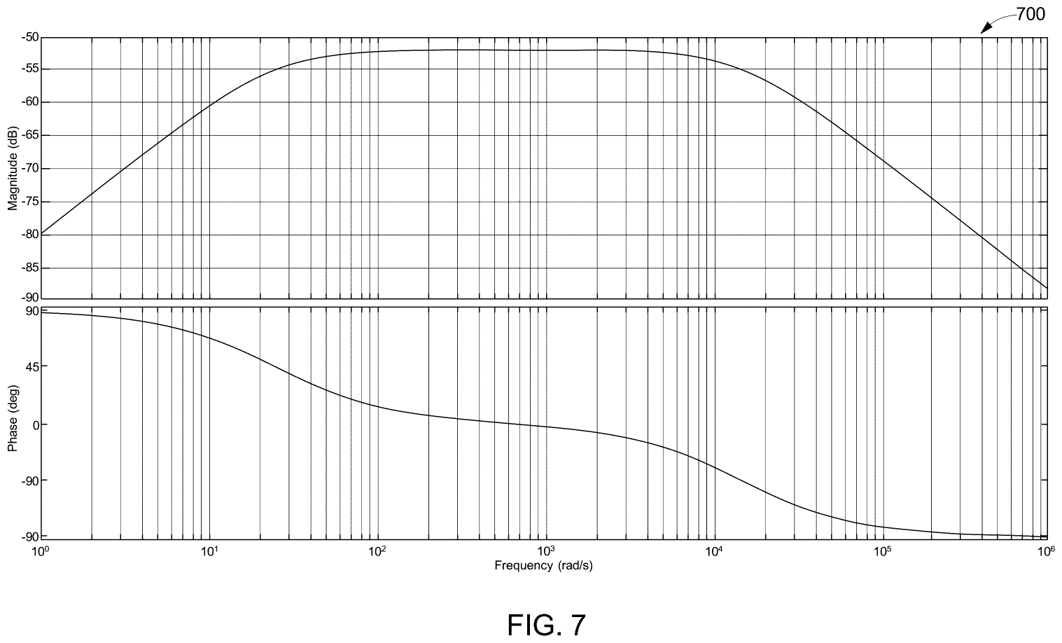

Referring now to FIG. 7, a graph 700 depicting RT output frequency in a transient state of the salient pole or non-salient pole inner or outer rotor synchronous machine 100 is illustrated, in accordance with another embodiment of the present disclosure. In an embodiment, when a specific DC current is required in the DC field windings of the main rotor 110 of the machine 100, a typical DC current command may be a step signal. A significant delay in the response may reduce the phase margin of the speed feedback of the machine 100. The analysis in the complex frequency domain of the RT 108 may be a key to design a stable and robust RT 108. For the analysis, the no-load current may be neglected, however, it may be considered for the steady state analysis of the DC current for an accurate control. Further, a mutual inductance between main rotor 110 and main stator 112 windings may be rotor position dependent, this may bring up complex computation for transient analysis. So, reference frame theory may be used to analyze the machine 100.

In some embodiments, the synchronous machine 100 may be capable of controlling the DC current in the DC field windings of the main rotor 110 without a current sensor in the main rotor 110. In order to control the DC field current I_{DC}, the equation below may be used. A lookup table may be preferred rather than online calculation, linear interpolation may be used to calculate the output for I_{DC} values that may not be in the table, but within its range.

In some embodiments, DC current may be controlled by measuring only the stator current and voltage, this provides with closed loop control capability of DC current without a current sensor in the rotor. All the parameters may be measurable, and the impedances are constant if applied frequency is constant.

In some embodiments, the synchronous machine 100 may be capable of detecting the temperature of the field windings of the machine 100 without a temperature sensor. The field winding temperature T may be easily calculated if

the field winding resistance is known at a reference temperature T_{ref} and at the operating temperature T.

$$T = \frac{{R}_{{F}_{T}}}{{R}_{{F}_{ref}}} ( τ + {T}_{ref} ) - τ . \qquad ( 5 )$$

where T=234.5° C. for copper in the operating temperature ranges of the machine. The field winding resistance may be determined as per equation (6):

$${R}_{{F}_{T}} = \frac{{U}_{DC}}{{I}_{DC}} \qquad ( 6 )$$

and the value of I_{DC} may be calculated using machine parameters.

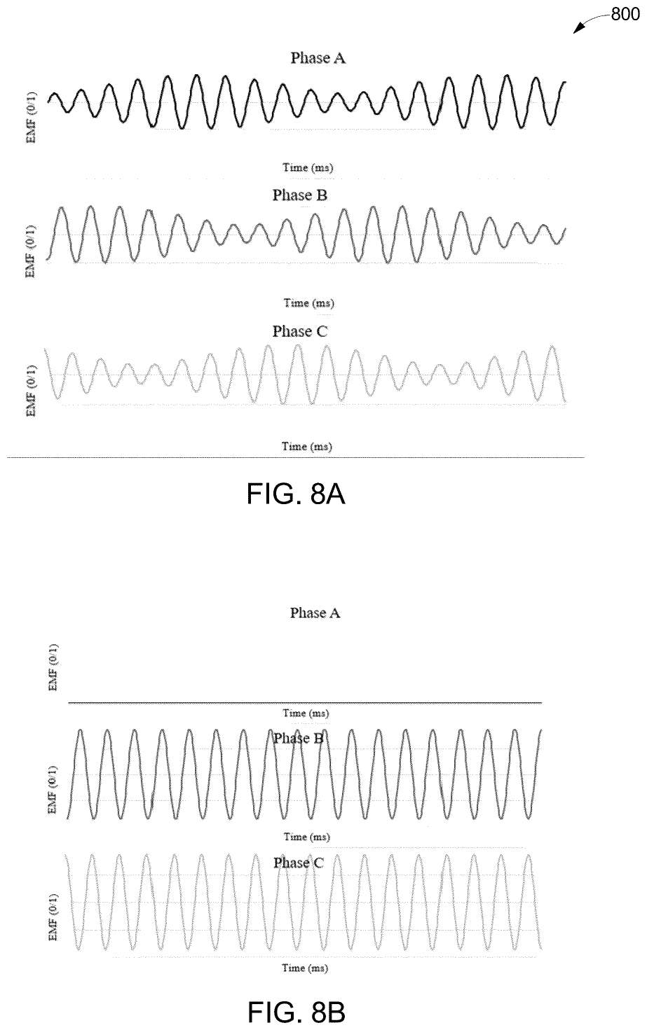

Referring now to FIG. 8A and FIG. 8B, EMF generated due to the auxiliary magnetic flux in each of the stator phases of the salient pole or non-salient pole inner or outer rotor synchronous machine is illustrated, in accordance with another embodiment of the present disclosure. In some embodiments, the detection of the EMF produced by the magnetic field of the machine 100 may help in detecting the main rotor 110 position without using sensors. However, there may be some problems in detecting the position of the main rotor 110. One of the problem may be that the EMF cannot be measured, it must be calculated with a machine mathematical model, which may be very inaccurate and may depend on temperature and saturation of the machine 100. Further, if the main rotor 110 is at stall, then there may not be any EMF in the machine 100, thus the position of the main rotor 110 may not be known.

There may be a method of detecting the rotor position which may not have the problems listed above. In some embodiments, The EMF eₛ₁ produced in the stator phases due to the machine main flux¹ may be calculated using equation below:

$${e}_{s 1 A} = {k}_{1} {I}_{1} ω cos ω t \qquad ( 7 )$$

$${e}_{s 1 B} = {k}_{1} {I}_{1} ω cos ( ω t - \frac{2}{3} π )$$

$$\{ {e}_{s 1 C} = {k}_{1} {I}_{1} ω cos ( ω t - \frac{4}{3} π )$$

I₁ is a DC field current and w the rotor angular speed. Note that the EMF is zero if rotor speed ω is zero.

Further, if a second AC field winding is built in the machine rotor, but now its current is i₂ and is an AC current, this current creates a flux that induces electromotive forces in each of the stator phases. These electromotive forces are used to calculate the rotor position.

Further, if another set of winding that is different to and is in addition to the phase winding, is built in the machine stator, then the i₂ current would also induce electromotive forces on this extra set of winding on stator. These electromotive forces may be used to calculate the rotor position.

Referring now to FIG. 8A, EMF due to the auxiliary magnetic flux in each of the stator phases at an arbitrary rotor speed ω and frequency ω₂ is illustrated with respect to each of the phase. Further, if the rotor is at stall, the EMF waveform due to auxiliary flux is illustrated in FIG. 8B. It should be noted that there may not be an EMF in phase A. If the angular position for the stalled rotor is different, the EMF may be zero too, but still, EMF may be present. The rotor angle θ can be calculated based on the induced EMFs.

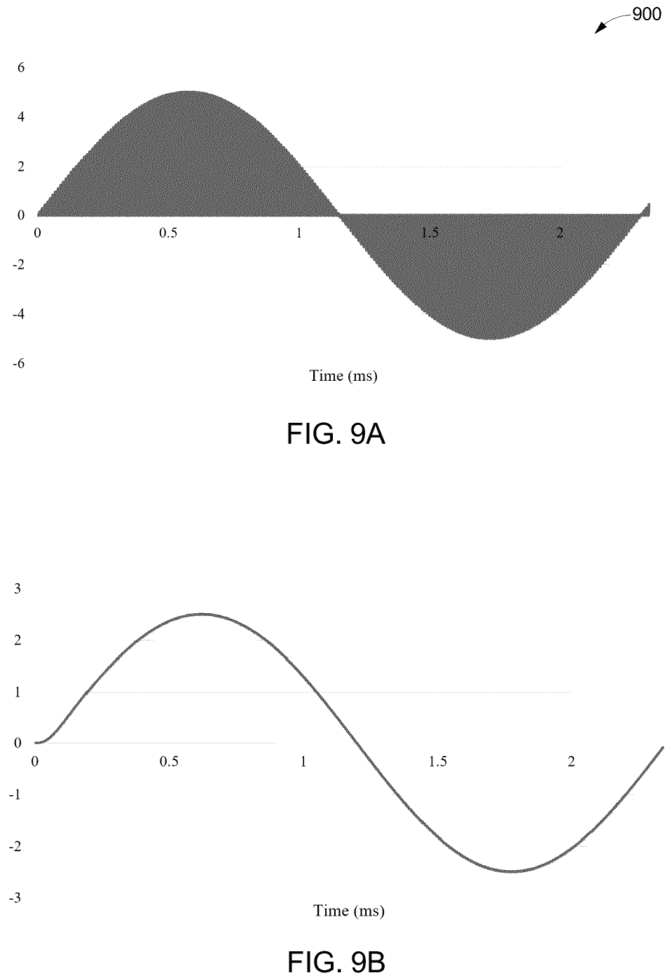

Referring now to FIG. 9A and FIG. 9B, a demodulation of a signal of each of the phase for signal recovery and rotor position detection of the salient pole or non-salient pole inner or outer rotor synchronous machine is illustrated, in accordance with another embodiment of the present disclosure. In some embodiments, to detect the accurate position of the rotor 110, the signal must be demodulated. Demodulation of the signal may be done by a product detection demodulation. The product detection demodulation may multiply the signal with a sinewave of same frequency and same phase as of the signal. It should be noted that the sinewave may not have same amplitude as the signal.

Accordingly, a low pass filter may yield result as illustrated in FIG. 9B. Further, the demodulated sinewave may detect the rotor 110 position using the low pass filtered EMFs.

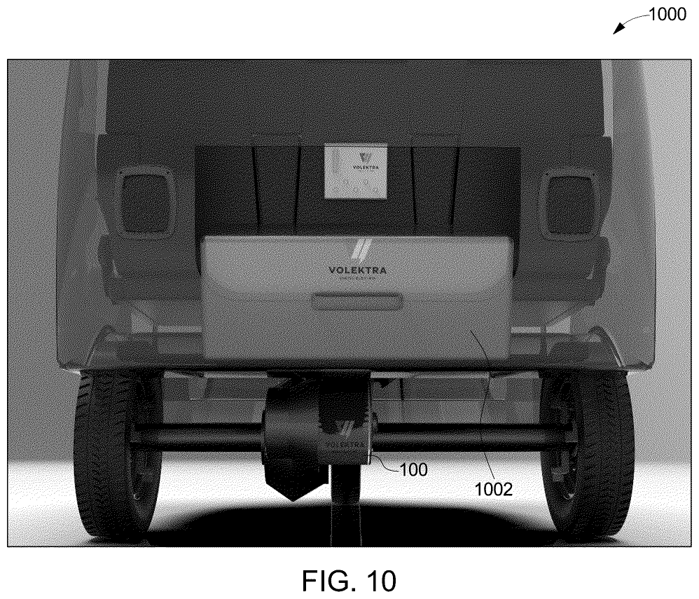

Referring now to FIG. 10, a rear perspective view of the salient pole or non-salient pole inner or outer rotor synchronous machine 100 installed in an exemplary vehicle 1000 is illustrated, in accordance with another embodiment of the present disclosure. The vehicle 1000 may be, but not limited to, an electric three-wheeler, an electric car, or any other electric commercial vehicle. The vehicle 1000 may include the synchronous machine 100 in the rear of the vehicle in this use case. It is to be noted that, the synchronous machine 100 may be placed anywhere in the vehicle 1000 depending on the design of the vehicle 1000. In some embodiments, the vehicle 1000 may include a battery pack 1002 which may provide power to the synchronous machine 100. Further, the synchronous machine 100 may power the drive train of the vehicle 1000.

The techniques described above relate to a magnetless and brushless rotating transformer excited synchronous machine and method of its control. The above techniques provide a cost-effective solution for reducing wear and tear in a synchronous machine. The techniques provide a more efficient and reliable synchronous machine that may be used for variety of purposes. The synchronous machine includes a rotating transformer that may replace the brushes and the slip rings in the machine thus reducing friction, and wear and tear. The techniques may also provide full speed range sensorless control and rotor temperature sensorless detection in the synchronous machine 100. Further, the technique provides a method to design the synchronous machine without magnets which may be beneficial for the environment. The synchronous machine 100 may handle high temperatures and demagnetizing currents as it has no magnets. Further, the techniques provide the capability for the synchronous machine to operate at any voltage between the operating range of voltage. The synchronous machine may also operate at any speed between the operating range of speed. Further, the use of RT in the synchronous machine may help in controlling the variable such as DC field winding current and the output frequency of the rotor. The synchronous machine may operate at an approximately constant frequency resulting in minimum power losses thus increased efficiency.

It is intended that the disclosure and examples be considered as exemplary only, with a true scope and spirit of disclosed embodiments being indicated by the following claims.

We claim:

1. A synchronous machine (100) excited using a rotating transformer (108), the synchronous machine comprising:
a housing (102) having a first opening (102A) and a second opening (102B);
a shaft (106) having a first end (106A) and a second end (106B);
a main motor (116) comprising:
a main rotor (110) co-axially mounted and positioned between the first end (106A) and the second end (106B) of the shaft (106), and having Direct Current (DC) field windings; a main stator (112) co-axially assembled over the main rotor (110) and mechanically supported by the housing (102), said main stator (112) having electrically coupled Alternating Current (AC) poly-phase distributed windings and a first predefined number of poles;
a rotating transformer (RT) (108) co-axially mounted and positioned between the first end (106A) and the second end (106B) of the shaft (106), said RT (108) having an RT rotor (120) configured to be rotatably coupled on the second end (106B) of the shaft (106),
said RT rotor (120) including AC poly-phase distributed windings and having a second predefined number of poles;
an RT stator (122) co-axially assembled over the RT rotor (120), wherein the RT stator (122) has AC poly-phase distributed windings and the second predefined number of poles; and
a three-phase rectifier (124) assembled on the shaft (106), wherein the three-phase rectifier (124) converts an AC current from the RT rotor (120) to a DC current, and wherein the DC current from the three-phase rectifier (124) is transmitted to the DC field windings of the main rotor (120) in order to excite the synchronous machine;
a first endcap (104A) configured to be attached to the first opening (102A) of the housing (102), wherein the first endcap (104A) is provided with an aperture (113) for the first end (106A) of the shaft to support an external radial load; and
a second endcap (104B) configured to be attached to the second opening (102B) of the housing (102), wherein the second endcap (102B) is provided with a groove (105) configured to support the second end (106B) of the shaft (106) and enable rotational movement of the shaft (106).

2. The synchronous machine (100) of claim 1, wherein the RT rotor (120) is configured to have a low magnetizing susceptance and a low frequency to speed factor (k_{f}).

3. The synchronous machine (100) of claim 1, wherein the RT stator (122) is configured to operate at a fixed frequency independent of a rotating speed of the RT rotor (120).

4. The synchronous machine (100) of claim 1, wherein the three-phase rectifier (124) is a poly-phase bridge diode rectifier, and
wherein the three-phase rectifier (124) is configured to operate at a frequency of the RT rotor (120).

5. The synchronous machine (100) of claim 1, wherein the RT stator (122) is configured to control magnetizing current in a voltage range to prevent saturation of a core of the RT stator (124).

6. The synchronous machine (100) of claim 1, wherein the RT (108) is configured to have a low output frequency variation with respect to a main rotor speed.

7. The synchronous machine (100) of claim 1, further comprising a first ball bearing (114A) coupled to the first end (106A) of the shaft (106) and a second ball bearing (114B) coupled to the second end (106B) of the shaft (106).

8. The synchronous machine (100) of claim 1, wherein a DC field winding current of the DC field windings of the main rotor (120) is dependent on a current of the RT stator (122).

9. The synchronous machine (100) of claim 1, wherein the RT (108) is controlled via a three-phase full bridge inverter using a pulse width modulation (PWM) technique.
